(19) United States
(12) Patent Application Publication
(10) Pub. No.: US 2005/0114313 A1
(43) Pub. Date: May 26, 2005

(54) System and method for retrieving documents or sub-documents based on examples

(76) Inventors: Christopher S. Campbell, San Jose, CA (US); Tomas J. Costello, San Jose, CA (US); Mahesh V. Joshi, San Jose, CA (US); Shivakumar Vaithyanathan, San Jose, CA (US); Huaiyu Zhu, Union City, CA (US)

Correspondence Address: Frederick W. Gibb, III;McGinn & Gibb, PLLC, Suite 304, 2568-A Riva Road, Annapolis, MD, 21401, US

(21) Appl. No.: 10/723,112

(22) Filed: Nov. 26, 2003

(51) Int. Cl. G06F 17/30

(52) U.S. Cl. 707/3

(57) ABSTRACT

Disclosed are a system, method, and program storage device implementing the method of extracting information, wherein the method comprises inputting a query; searching a database of documents based on the query; retrieving documents from the database matching the query using a plurality of classifiers arranged in a hierarchical cascade of classifier layers, wherein each classifier comprises a set of weighted training data points comprising feature vectors representing any portion of a document; and weighing an output from the cascade according to a rate of success of query terms being matched by each layer of the cascade, wherein the weighing is performed using a terminal classifier.

### BACKGROUND OF THE INVENTION

1. Field of the Invention

The invention generally relates to retrieving, organizing, and indexing documents, and more particularly to a process for information extraction from large text collections operating by taking as an example either a few documents or a portion of a few documents.

2. Description of the Related Art

Within this application several publications are referenced by Arabic numerals within brackets. Full citations for these, and other, publications may be found at the end of the specification immediately preceding the claims. The disclosures of all these publications in their entireties are hereby expressly incorporated by reference into the present application for the purposes of indicating the background of the present invention and illustrating the state of the art.

Several real world problems fall into the category of single class learning, where training data is available for only a single class. Examples of such problems include the identification of a certain class of web-pages from the Internet; e.g., “personal home pages” or “call for papers”^{[12]}. Building training data for such problems can be a particularly arduous task. For example, consider the task of building a classifier to identify pages about IBM. Certainly, all pages that mention IBM are not about IBM. To build such a binary classifier would require a sample of positive examples that characterize all aspects that can be considered to be about IBM. Constructing a negative class would require a uniform representation of the universal set excluding positive class^{[12]}. This is too laborious a task to be performed manually.

Information extraction is yet another area where a significant number of problems fall into the category of single-class learning. Ranging from identifying named-entities to extracting user-expressed opinion from a body of text, information extraction has a wide array of problems. Information needs of users are quite diverse and numerous thus precluding the creation of significant numbers of labeled examples. For example, consider an oil company's corporate reputation management group interested in monitoring articles about its and its competitor's image in the areas of diversity at work place, oil spill issues, environmental policies etc. Obtaining positive and negative labeled data for each such topic is almost impossible. Users are typically willing to provide very few carefully crafted hand-labeled data. It is precisely this single-class problem with very few labeled examples, which is has not been addressed by conventional solutions.

The need for single-class learning has been recognized and there have been a few previous efforts focusing on learning from positive examples. In one conventional approach^{[9]}, the solution operates by trying to map the data using a kernel and then using the origin as the negative class. In practice this conventional technique has been found to be very sensitive to parametric changes^{[5]}, where it has been suggested to include some heuristic modifications to include more than just the origin into the negative class. Recent work on including unlabeled examples in an iterative framework that identifies examples that do not share features with positive examples has been described^{[12]}. These are treated as negative examples to learn a support vector machine. Moreover, these approaches have concentrated on identifying negative examples and using them in a discriminative training framework. The motivation in these approaches has been towards building classifiers that do not degrade in accuracy with the growth in the size of labeled data^{[12]}.

Generative modeling approaches have also been applied to the problem of partially labeled data. Unsupervised approaches to modeling use joint distributions over the features to identify clusters in the data. In particular, finite mixture models, whose parameters are learned using the popular expectation maximization (EM) methodology, are used extensively. Another conventional approach^{[6]} modifies the EM methodology to allow for the incorporation of labeled data. This approach can be used with very limited labeled data. A variant of this approach to the single-class problem, but with larger amounts of labeled data, has been described in other solutions as well^{[4]}.

Query-by-example (QBE) has been around for a long time. However, the problem has not been successfully treated in the past. Existing methods treat the problem in a simplistic fashion. The most popular technique is nearest neighbor. Besides nearest neighbor, some simple partially supervised methods have been used, without complete success.

Consider the following latent variable model:

$$p ( z ) = {\sum }_{a} p ( z \vert a ) \cdot p ( a ) . \qquad ( 1 )$$

Such models are useful in classification problems where the latent variable a is interpreted as class labels. Training of this model involves adjusting the parameters of the probability distributions p(z|a) and p(a). This model can be trained effectively using the EM methodology. Next, one derivation of the EM methodology that will be extended subsequently to the invention's multistage methodology is provided. Given a dataset {z₁, z₂, . . . , zₙ} of individual observations of z, the log likelihood of the model is:

$${\sum }_{i} log p ( {z}_{i} ) = {\sum }_{i} log {\sum }_{a} p ( {z}_{i} \vert a ) \cdot p ( a ) . \qquad ( 2 )$$

The EM methodology is derived by introducing an indicator-hidden variable. Writing the bound, and taking expectations of equation (2), it can be shown that the log-likelihood of the model is bounded from below by the following Q function:

$$Q = {\sum }_{i} {\sum }_{a} q ( a \vert {z}_{i} ) \cdot log p ( {z}_{i} \vert a ) \cdot p ( a ) \qquad ( 3 )$$

where q(a|zᵢ) is equal to p(a|zᵢ). The Q function is proportional to the log-likelihood of the joint distributions log p(a, z). The EM methodology is defined by maximizing Q, instead of the original log-likelihood, in an iterative process comprising the following two steps: (1) E-Step: Compute q(a|zᵢ)=p(a|zᵢ) keeping the parameters fixed; (2) M-Step: Fix q(a|zᵢ) in equation (3) and obtain the maximum likelihood estimate of parameters of p(zᵢ|a) and p(a).

A labeled example, which is also referred to as a seed in the description of the present invention, is a data point that is known to a particular class (topic) of interest. The EM methodology for the model shown in equation (1) is an unsupervised methodology; that is, there are no labeled examples. Thus, a few labeled examples for the class of interest must be introduced. Incorporating this information into the EM methodology results in a semi-supervised version^{[6]}. Again, the EM methodology introduces a hidden variable, and in the E-step the methodology computes the expected value of these hidden variables. For the labeled examples the value of the hidden variable is known. It will be assumed that a=1 is the class of interest. Instead of computing the expected value in the E-step the semi-supervised methodology simply assigns q(a=1|z_{seed})=1 and q(a≠|z_{seed})=0. This will be referred to as “seed constraint.”

However, with very few labeled examples, seed constraints alone are not sufficient to tackle the above-identified problem. Thus, a more powerful model and methodology are needed. Therefore, due to the limitations of the conventional approaches, there remains a need for a novel QBE process used for single-class learning, which overcomes the problems of the conventional designs.

### SUMMARY OF THE INVENTION

In view of the foregoing, the invention provides a system for extracting information comprising a query input; a database of documents; a plurality of classifiers arranged in a hierarchical cascade of classifier layers, wherein each classifier comprises a set of weighted training data points comprising feature vectors representing any portion of a document, and wherein the classifiers are operable to retrieve documents from the database matching the query input; and a terminal classifier weighing an output from the cascade according to a rate of success of query terms being matched by each layer of the cascade, wherein each classifier accepts an input distribution of the training data points and transforms the input distribution to an output distribution of the training data points, wherein each classifier is trained by weighing training data points at each classifier layer in the cascade by an output distribution generated by the preceding classifier layer, wherein weights of the training data points of the first classifier layer are uniform, wherein each classifier is trained according to the query input, and wherein the query input is based on a minimum number of example documents. The documents comprise any of text files, images, web pages, video files, and audio files. In fact, the documents comprise a file format capable of being represented by feature vectors.

According to the invention a classifier at each layer in the hierarchical cascade is trained with an expectation maximization methodology that maximizes a likelihood of a joint distribution of the training data points and latent variables. Each layer of the cascade of classifiers is trained in succession from a previous layer by the expectation maximization methodology, wherein the output distribution is used as an input distribution for a succeeding layer. Alternatively, each layer of the cascade of classifiers is trained by successive iterations of the expectation maximization methodology until a convergence of parameter values associated with the output distribution of each layer occurs in succession, wherein the successive iterations comprise a fixed number of iterations.

In another embodiment, all layers of the cascade of classifiers are trained by successive iterations of the expectation maximization methodology until a convergence of parameter values associated with output distributions of all layers occurs, wherein during each step of the of the iterations, the output distribution of each layer is used to weigh the input distribution of a succeeding layer. The terminal classifier generates a relevancy score associated with each data point, wherein the relevancy score comprises an indication of how closely matched the data point is to the example documents, wherein the relevancy score is computed by combining the relevancy scores generated by classifiers at each layer of the cascade. In an embodiment of the invention, the terminal classifier generates a relevancy score associated with a document, wherein the relevancy score is calculated from relevancy scores of individual data points within the document. Alternatively, each classifier layer generates a relevancy score associated with each data point, wherein the relevancy score comprises an indication of how closely matched the data point is to the example documents. According to another embodiment of the invention features of the feature vectors comprise words within a range of words located proximate to entities of interest in the document.

In another embodiment, the invention provides a method of extracting information, wherein the method comprises inputting a query; searching a database of documents based on the query; retrieving documents from the database matching the query using a plurality of classifiers arranged in a hierarchical cascade of classifier layers, wherein each classifier comprises a set of weighted training data points comprising feature vectors representing any portion of a document; and weighing an output from the cascade according to a rate of success of query terms being matched by each layer of the cascade, wherein the weighing is performed using a terminal classifier.

The invention works in a novel way by weighing data at each stage by the output distribution from the previous stage. In the first stage the previous output distribution is assumed to be uniform. In the process it creates these sets of information, whereby as one moves further away from the core, the topic is less related to what is wanted.

These and other aspects and advantages of the invention will be better appreciated and understood when considered in conjunction with the following description and the accompanying drawings. It should be understood, however, that the following description, while indicating preferred embodiments of the invention and numerous specific details thereof, is given by way of illustration and not of limitation. Many changes and modifications may be made within the scope of the invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a flow diagram illustrating a preferred method of the invention;

FIG. 2 is a graphical representation of according to an embodiment of the invention;

FIG. 3 is a graphical representation of according to an embodiment of the invention;

FIG. 4 is a graphical representation of according to an embodiment of the invention;

FIG. 5 is a system diagram according to an embodiment of the invention; and

FIG. 6 is a system diagram according to an embodiment of the invention.

### DETAILED DESCRIPTION OF PREFERRED EMBODIMENTS OF THE INVENTION

The invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the invention. The experiments described and the examples used herein are intended merely to facilitate an understanding of ways in which the invention may be practiced and to further enable those of skill in the art to practice the invention. Accordingly, the experiments and examples should not be construed as limiting the scope of the invention.

As mentioned, there is a need for a novel QBE process used for single-class learning, which overcomes the problems of the conventional designs. Referring now to the drawings and more particularly to FIGS. 1 through 6, there are shown preferred embodiments of the invention. FIG. 1 illustrates a flow diagram illustrating a method of extracting information, wherein the method comprises inputting 100 a query; searching 110 a database of documents based on the query; retrieving 120 documents from the database matching the query using a plurality of classifiers arranged in a hierarchical cascade of classifier layers, wherein each classifier comprises a set of weighted training data points comprising feature vectors representing any portion of a document; and weighing 130 an output from the cascade according to a rate of success of query terms being matched by each layer of the cascade, wherein the weighing is performed using a terminal classifier. The documents comprise any of text files, images, web pages, video files, and audio files. In fact, the documents comprise a file format capable of being represented by feature vectors.

According to an embodiment of the invention each classifier accepts an input distribution of the training data points and transforms the input distribution to an output distribution of the training data points, wherein each classifier is trained by weighing training data points at each classifier layer in the cascade by an output distribution generated by each previous classifier layer, wherein weights of the training data points of the first classifier layer are uniform, wherein each classifier is trained according to the query input, and wherein the query input is based on a minimum number of example documents.

The invention also provides a classifier at each layer in the hierarchical cascade is trained for each layer with an expectation maximization methodology that maximizes a likelihood of a joint distribution of the training data points and latent variables. Each layer of the cascade of classifiers is trained in succession from a previous layer by the expectation maximization methodology, wherein the output distribution is used as an input distribution for a succeeding layer. Alternatively, each layer of the cascade of classifiers is trained by successive iterations of the expectation maximization methodology until a convergence of parameter values associated with the output distribution of each layer occurs in succession, wherein the successive iterations comprise a fixed number of iterations.

In another embodiment, all layers of the cascade of classifiers are trained by successive iterations of the expectation maximization methodology until a convergence of parameter values associated with output distributions of all layers occurs, wherein during each step of the of the iterations, the output distribution of each layer is used to weigh the input distribution of a succeeding layer. The terminal classifier generates a relevancy score associated with each data point, wherein the relevancy score comprises an indication of how closely matched the data point is to the example documents, and wherein the relevancy score is computed by combining the relevancy scores generated by classifiers at each layer of the cascade.

In an embodiment of the invention, the terminal classifier generates a relevancy score associated with a document, wherein the relevancy score is calculated from relevancy scores of individual data points within the document. Alternatively, each classifier layer generates a relevancy score associated with each data point, wherein the relevancy score comprises an indication of how closely matched the data point is to the example documents.

According to the invention, a feature vector is a vector of counts for all the features in a data point. For example, if a data point is a text document, then a feature can be a word, an n-gram, a stemmed word, or other features used in linguistic tokenization, and a feature vector is a vector of counts of how many times each word appears in the document. Additionally, the feature vectors may comprise words within a range of words located proximate to certain entities of interest appearing in the documents from which the data points are formed.

The invention provides a semi-supervised query-by-example methodology for single class learning with very few examples. The problem is formulated as a hierarchical latent variable model, which is clipped (edited) to ignore classes not of interest. The model is trained using a multi-stage EM methodology. The multi-stage EM methodology maximizes the likelihood of the joint distribution of the data and latent variables, under the constraint that the distribution of each layer is fixed in successive stages. The invention uses a hierarchical latent variable model and in contrast to conventional approaches, the invention concentrates only on the class of interest. Furthermore, the invention's methodology uses both labeled and unlabeled examples in a unified model. As is further discussed below, under certain conditions, namely when the underlying data have hierarchical structures, the invention's methodology performs better than training all layers in a single stage. Finally, as described below, experiments are conducted to verify the performance of the methodology on several real-world information extraction tasks.

Next, extensions to the simple latent variable model described above are discussed. To begin with, a hierarchical latent variable model followed by a constrained version of this hierarchical model suitable for single-class classification are described.

Consider a two level hierarchical model:

$$p ( {z}_{i} ) = {\sum }_{{a}_{0} , {a}_{1}} p ( {z}_{i} \vert {a}_{0} , {a}_{1} ) \cdot p ( {a}_{1} \vert {a}_{0} ) \cdot p ( {a}_{0} ) \qquad ( 4 )$$

where a₀ and a₁ are the two levels in the hierarchy. Given the same observed data, the likelihood is:

$${\prod }_{i} p ( {z}_{i} ) = {\prod }_{i} {\sum }_{{a}_{0} , {a}_{1}} p ( {z}_{i} \vert {a}_{0} , {a}_{1} ) \cdot p ( {a}_{1} \vert {a}_{0} ) \cdot p ( {a}_{0} ) \qquad ( 5 )$$

If the task is only to identify a single class from multiple possibilities, there is a trade-off between the number of hidden classes (hence the computational cost) and the precision of the chosen class. The mixture model (1) represents not only the required class but also other classes present in the data. Training such a simple model has two significant drawbacks: if the number of components in the mixture model is small then the chosen class will contain most of the items of interest along with a large number of spurious items. If the number of classes is large, the conventional EM methodology spends much of the computational resources in training large number of classes that are not of interest. Similarly, a full-blown model of the form (4) can be expensive to train due to the combinatorial effect of the hierarchical hidden variables in the E-step.

If the data has a hierarchical structure, it is intuitively plausible that a methodology that progressively “zooms in” on the identified class may be beneficial. This is beneficial because the computing resource is not used for discriminating between other topics not of interest. In particular, if one is interested in a=1 it might appear that a “clipped model” of the following form could be effective:

$$p ( {z}_{i} ) = {\sum }_{{a}_{0} = 1} p ( {a}_{0} ) {\sum }_{{a}_{1}} p ( {a}_{1} \vert {a}_{0} ) \cdot p ( {z}_{i} \vert {a}_{0} , {a}_{1} ) + {\sum }_{{a}_{0} \neq 1} p ( {a}_{0} ) p ( {z}_{i} \vert {a}_{0} ) \qquad ( 6 )$$

However, this zooming effect cannot be achieved with training in a single stage.

The clipped model (6) is advantageous if the training is performed in the following stagewise fashion: layer m is trained in stage m by fixing all of the layers before m. The log-likelihood of the model

$${\sum }_{i} log p ( {z}_{i} )$$

can be written as^{[1]}:

$$N {\sum }_{i} q ( {z}_{i} ) log p ( {z}_{i} ) , \qquad ( 7 )$$

where q(zᵢ)=1/N is the output distribution of the dataset and N is the size (number of datapoints) of the dataset.

The EM methodology can be generalized to maximize the objective function:

$${\sum }_{i , a} q ( {z}_{i} ) q ( a \vert {z}_{i} ) log p ( {z}_{i} a ) , \qquad ( 8 )$$

in the M step, where q(a|zᵢ)is fixed in the E step asp(a|zᵢ). The objective function of equation (3) is a special case of this objective function, when q(zᵢ) is uniform over all zᵢ. For the clipped hierarchical model, the E step calculates
q(a₀,a₁|zᵢ)=p(a₀,a₁,zᵢ)=p(zᵢ,a₀,a₁)/p(zᵢ), (9)
subject to the seed constraints, and the M Step maximizes

$${\sum }_{i} q ( {z}_{i} ) {\sum }_{{a}_{0}} q ( {a}_{0} , {a}_{1} \vert {z}_{i} ) log p ( {z}_{i} , {a}_{0} , {a}_{1} ) . \qquad ( 10 )$$

According to the invention, the multistage EM methodology trains each layer successively while imposing layered constraints on both q and p. In one embodiment of the invention, this training is performed in a two-stage process. In the first stage, a₀ is the only latent variable. The M step maximizes:

$${\sum }_{i}^{} {\sum }_{{a}_{0}}^{} q ( {z}_{i} , {a}_{0} ) log p ( {z}_{i} , {a}_{0} ) , \qquad ( 11 )$$

where q₀(zᵢ)=q(zᵢ)=1/N is fixed to the output distribution and q(a₀|zᵢ)=p(a₀|zᵢ) is calculated in the E step, subject to the seed constraints. The final values, which p and q converge to, are denoted p₀ and q₀. These will not be changed in subsequent stages. The second stage involves latent variables a₀ and a₁. The M step maximizes

$${\sum }_{i}^{} {\sum }_{{a}_{0} , {a}_{1}}^{} q ( {z}_{i} , {a}_{0} , {a}_{1} ) log p ( {z}_{i} , {a}_{0} , {a}_{1} ) , \qquad ( 12 )$$

with the condition that
q(zᵢ,a₀)=q₀(zᵢ,a₀), (13)
p(a₀)=p₀(a₀), (14)
p(zᵢ|a₀)=p₀(zᵢ|a₀), ∀a₀≠1. (15)

In other words, only the part of model that involves a₁ is allowed to change, and it is regarded that q(zᵢ,a₀) is the output distribution of “expanded data” involving both z and a₀. To derive the M step, the objective function is expanded as

$$\begin{matrix} {\sum }_{i} {\sum }_{{a}_{0} , {a}_{1}}^{} q ( {z}_{i} , {a}_{0} , {a}_{1} ) log p ( {z}_{i} , {a}_{0} , {a}_{1} ) = \\ {\sum }_{{a}_{0}}^{} q ( {a}_{0} ) log p ( {a}_{0} ) + \\ {\sum }_{{a}_{0} \neq 1}^{} {\sum }_{{z}_{i}}^{} q ( {z}_{i} , {a}_{0} ) log p ( {z}_{i} \vert {a}_{0} ) + \\ {\sum }_{{a}_{0} = 1}^{} {\sum }_{{z}_{i} , {a}_{1}}^{} q ( {z}_{i} , {a}_{0} , {a}_{1} ) log p ( {z}_{i} , {a}_{1} \vert {a}_{0} )\end{matrix} \qquad ( 16 )$$

On the right hand side of equation (16) since p(a₀) is fixed, the first term is constant. Since p(zᵢ|a₀) is fixed for a₀≠1, the second term is constant. To maximize the third term, consider the following factorization (keeping in mind that a₀=1)
q(zᵢ,a₀,a₁)=q(a₀)q(zᵢ|a₀)q(a₁|zᵢ,a₀) (17)
Both q(a₀) and q(zᵢ|a₀) are fixed from the previous layer. The last factor, subject to seed constraints, is calculated as (E step):
p(a₁|zᵢ,a₀=1)=p(a₁|zᵢ)=q₁(a₁|zᵢ) (18)
Therefore the M step maximizes

$${\sum }_{i}^{} {\sum }_{{a}_{1}}^{} {q}_{1} ( {z}_{i} ) {q}_{1} ( {a}_{1} \vert {z}_{i} ) log {p}_{1} ( {z}_{i} , {a}_{1} ) , \qquad ( 19 )$$

where we have defined q₁(zᵢ)=q₀(zᵢ|a₀=1).

For the multistage EM, when training for the distributions involving a₁, the expanded output distribution q(zᵢ,a₀) is fixed from the previous layer. In contrast, for the full EM methodology, only q₁(zᵢ) is fixed at any time of the training process. This can be generalized to multiple layers. For layer m, the M step computes pₘ(zᵢ,aₘ) to maximize

$${\sum }_{i}^{} {\sum }_{{a}_{m}}^{} {q}_{m} ( {z}_{i} ) {q}_{m} ( {a}_{m} \vert {z}_{i} ) log {p}_{m} ( {z}_{i} , {a}_{m} ) , \qquad ( 20 )$$

where qₘ(zᵢ)=qₘ₋₁(zᵢ|aₘ₋₁=1) comes from layer m−1 and qₘ (aₘ|zᵢ)=pₘ(aₘ|zᵢ), subject to seed constraints, is calculated in the E step.

The basic idea behind the methodology provided by the invention is that by weighing each datapoint with qₘ(zᵢ), less emphasis is placed on those zᵢ that are less likely to be in class 1. Again, this is beneficial because the computing resource is not used for discriminating between other topics not of interest. The discrimination in layer m could conceivably concentrate on finer details difficult to be addressed at layer m−1.

Next, there is a relationship between the multi-stage EM methodology provided by the invention and boosted density estimation provided by other approaches[^{8]}. At each stage m in the multi-stage EM methodology the model built so far is denoted by:

$$\begin{matrix}{F}_{M} ( z ) = {\sum }_{{a}_{0} \neq 1}^{} p ( {a}_{0} ) p ( z \vert {a}_{0} ) + \\ p ( {a}_{0} = 1 ) {\sum }_{{a}_{1} \neq 1}^{} p ( {a}_{1} \vert {a}_{0} = 1 ) p ( z \vert {a}_{0} = 1 , {a}_{1} ) + … + \\ {\prod }_{m = 0}^{M - 1} p ( {a}_{m} = 1 \vert {a}_{m - 1} = 1 ) \\ {\sum }_{{a}_{M}}^{} p ( {a}_{M} \vert {a}_{M - 1} = 1 ) p ( z \vert {a}_{M - 1} = 1 , {a}_{M} ) .\end{matrix} \qquad ( 21 )$$

In a departure from conventional methods^{[8]} the patterns in each successive layer are weighted using the output distribution from the previous layer. This suggests that the invention weighs the patterns according to how well they performed in the previous layer. This is so because, unlike boosted density estimation, one of the objects of the invention is classification error. The invention's partially supervised methodology is concerned with the classification of a single class but is also trying to improve the classification by trying to get successively better density estimates for that single class. Another difference between the conventional methods^{[8]} and the invention is the fact that the invention is a learning methodology using the weights within the iterations of the EM methodology. More specifically, the weights are used in the M-Step as described in equation (19). The multi-stage EM methodology in boosting framework is indicated below:
1. Set the initial weights wᵢ=1/N.
2. For m=1 to M
   (a) Use the EM methodology to compute pₘ(zᵢ|a) and pₘ(a) to maximize Σᵢwᵢ log Σₐpₘ(zᵢ|a)pₘ(a), subject to seed constraints.
   (b) Set wᵢ=qₘ₋₁(zᵢ|aₘ₋₁=1).
3. Output final model F_{M}.

As mentioned, information extraction from large text collections is an important problem. Within this class a particularly interesting problem is that of identifying appropriate topics. In particular, one concern is with the problem of identifying topics in relationship to specific named-entities as is described in detail below. Often users are interested in information pertaining to a specific person (or persons), company(ies) or place(s). These names of people, companies and places have a special place in natural language processing and are called named-entities. The reason for the special treatment is that these are valuable, non-ambiguous, user-defined terms. For example, consider a user who is interested in keeping track of Intel Corporation's strategy to produce cheaper, faster and thermally more efficient microchips and microprocessors. Ideally, the user should be able to express this query in natural language and the system would respond with the answer.

Recognizing that named-entities are important, unambiguous, user-defined terms anchored topic retrieval uses the immediate context of these named-entities to determine the topic pertaining to them. Consider, e.g., the portion of a document shown below:
Intel has not reduced its capital spending budget of $7.5 billion for the year, in part to accommodate the introduction of 300-millimeter wafer production. Chips produced on the new wafers will be made with the more advanced 0.13-micron manufacturing process and contain copper wires. Intel currently makes its chips with the 0.18-micron manufacturing process and uses aluminum. The micron measurements refer to the size of features on the chip. The shift will result in smaller, cooler, faster and cheaper processors. “Intel expects chips produced on 300-millimete wafers to cost 30 percent less than those made using the smaller wafer,” Tom Garret, Intel's 300-millimeter program manager, said in a statement.

Clearly, the discussion is about Intel moving to a 0.13 micron manufacturing process using a 300 mm wafer, which will reduce Intel's manufacturing cost, increase the speed and produce cooler chips and would be relevant to the query. However, not all relevant occurrences of Intel will necessarily contain the terms faster, cheaper and cooler in its context. The complicated semantic nature of the query requires a more sophisticated response.

The anchored topic retrieval problem uses an example, of the sort shown above, as a substitute for the query. The name is derived from the fact that the portion of the document used as a query is anchored on named-entities (Intel in this example). The underlying corpus is processed and every occurrence of the named-entity, with its associated context, is considered a candidate. Formally the problem is described as follows: We are given a set of identified anchors in documents and a query q, which is a small sub-set of the identified anchors. The problem at hand is to classify the remaining anchors as being relevant to the query or not.

Surrounding each anchor is a context. The context is restricted to tokens within l characters on each side of the anchor. The text within the window is tokenized into words. Partial words at the boundaries of the window and stop words are removed. Suffix stemming is performed using the well-known Porter's stemmer on each word. This results in a sequence of tokens. Furthermore, lexical affinities; i.e., pairs of tokens within a window of five tokens of each other are also used as features. All terms that occur in less than three contexts are discarded. The context around each anchor is now represented as a vector of features, each feature being either a token or a bigram.

Each zᵢ in the anchored topic retrieval consists of an anchor xᵢ and context yᵢ. It is assumed in the model that conditioned on the latent variable, the anchor and the context are independent. The simple latent variable model for the anchored retrieval problem is therefore written as:

$$p ( {x}_{i} , {y}_{i} ) = {\sum }_{a}^{} p ( {x}_{i} \vert a ) \cdot p ( {y}_{i} \vert a ) \cdot p ( a ) \qquad ( 22 )$$

The hierarchical and the clipped models, mentioned before, can be extended to include xᵢ and yᵢ. The probability model assumed for p(xᵢ|a) is a simple multinomial where each xᵢ takes on one of X possible unique anchor values. The probability model for p(yᵢ|a) is a vector with length equal to the size of the dictionary obtained using the previously described preprocessing. The anchored topic retrieval problem has some specific characteristics peculiar to the problem. Foremost, limiting the context of every anchor results in a text classification problem that has all documents of approximately the same length. Further, the limited context keeps the length of the document short. Moreover, since the context is around a named-entity it is often true that the topic of discussion is fairly focused. At first glance this might seem like an easy problem. However, the limitation of very few labeled examples increases the difficulty of the task.

Experiments on real-world datasets have been conducted to prove the validity of an embodiment of the invention. The document collection is gathered from the Tech News section of an online website, Cnet, by crawling the site for news articles and extracting them in an XML format. The news articles are mostly about the business aspects of information technology companies. A total of 17,184 documents were retrieved over a period of several weeks. Duplicates were removed using a cosine similarity measure on the frequency of tokens, leaving 5,268 unique documents in the collection. It is not uncommon for a single article to discuss multiple topics, sometimes interleaved. For instance, industry analysts may publish their opinions on several companies or technologies in a single article. These real-world characteristics of the news article collection make this an interesting and challenging testbed for the invention's methodology.

Anchors can be spotted either as named entities, as given patterns of regular expressions, or as an explicitly given set of names. For the experiments with CNet Tech News articles, a commercially available named-entity tagger^{[7]} is used. It identified 7116 unique entities as organizations in various contexts. This list contains many false positives. However, to test the robustness of the methodology, experiments were conducted with several ways of reducing this list. The list was pruned by visual inspection resulting in a list of 2151 unique entities with a total of 87,251 occurrences in the corpus. Since one of the queries used to test the invention's methodology is in the semiconductor manufacturing domain, the list of 2151 entities was pruned and all names that were definitely not semiconductor manufacturers were removed, resulting in a list of 181 different names with a total of 29,253 occurrences.

For the multistage methodology the number of components in the mixture model was kept at two. Laplace's rule is used for smoothing. For comparison, the experiment evaluated the invention against two standard methodology namely; nearest neighbor^{[11}] and the single layer latent variable model trained using the partially supervised EM methodology^{[6]}. For both topics a type of proximity search was also tested based on patterns given by domain experts. The proximity search is performed on the identified anchors with the original (not tokenized) contexts for varying window sizes.

The experiments were conducted in two domains: semiconductor manufacturing and Web Services. The specific topics within these domains can be described by the following descriptions: (1) Topic 1 includes steps taken by semiconductor manufacturers to produce cheaper, faster and thermally more efficient microprocessors and microchips; and (2) Topic 2 includes web service protocols for business process integration. The topics used in these evaluations are chosen specifically to illustrate the advantages and potential pitfalls of using unlabeled documents within the model. Specifically, Topic 1 is chosen to be a broad topic and the chosen seeds are such that the overall essence of the topic is captured by the entire context. On the other hand Topic 2 is chosen as a narrow topic. For this topic existence of specific words and/or phrases is sufficient to indicate whether the anchor belongs to the topic. For semiconductor manufacturing, three anchors occurring in two documents are identified from the corpus as relevant to the query. In web services, three anchors from three documents are selected as seeds. Results produced by the retrieval methodology are manually evaluated by the domain experts, producing precision recall results described below.

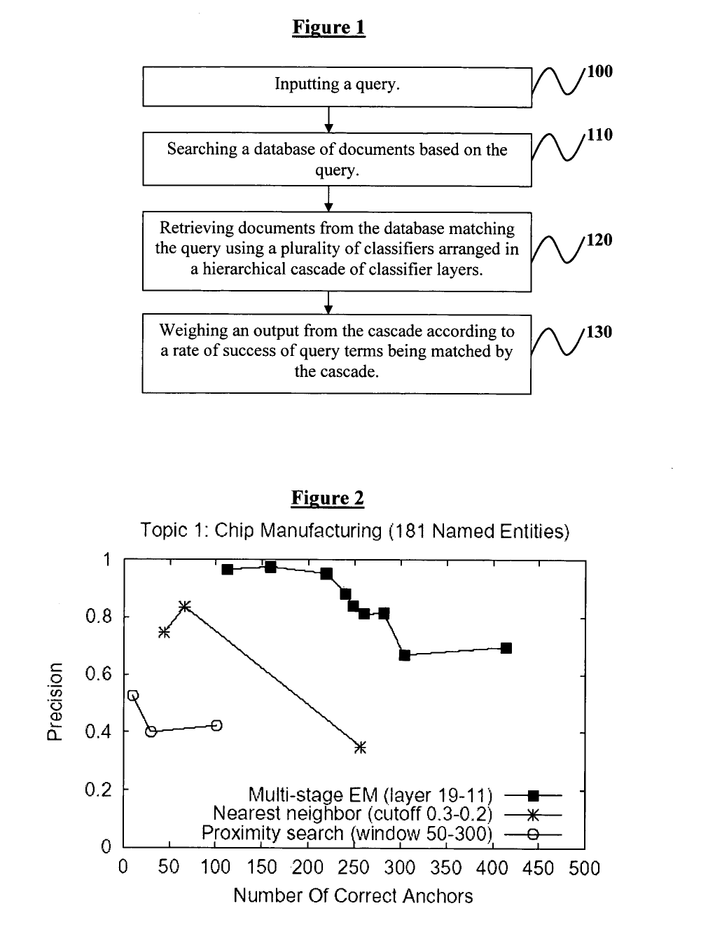

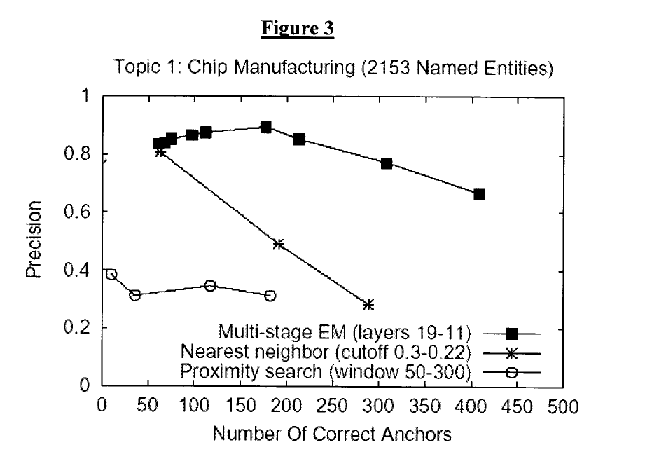

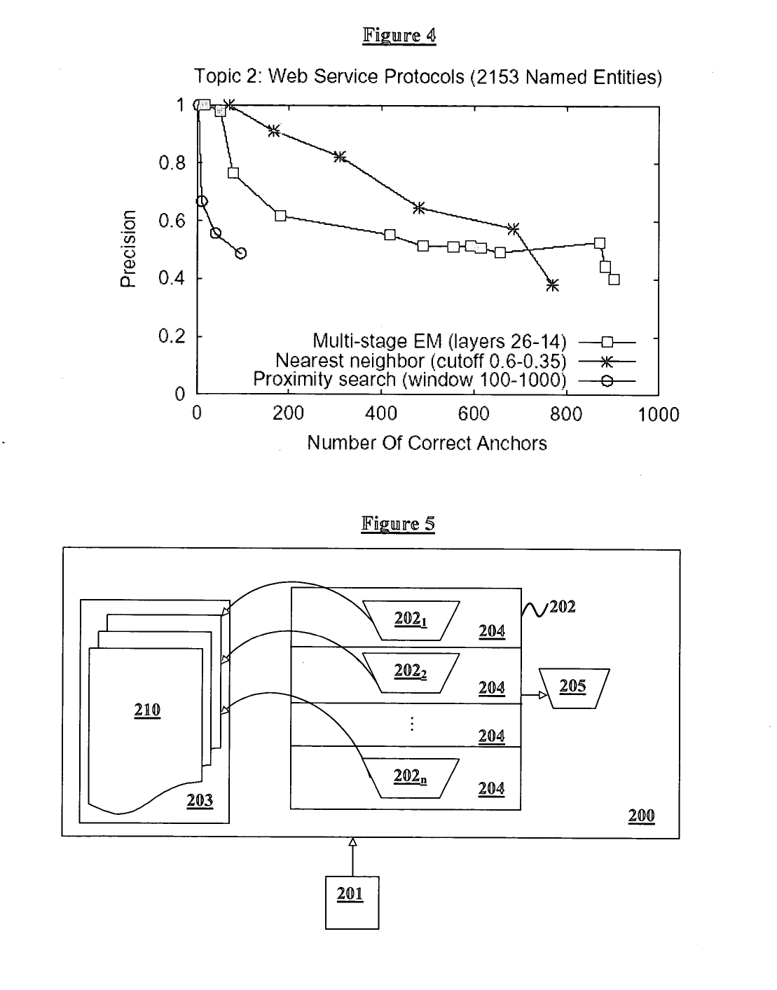

The results obtained by the methodology on different parameter settings are shown in FIGS. 2, 3 and 4. For Topic 1 the multistage EM methodology was run for 19 layers, and for Topic 2 it was run for 26 layers. An immediate glance of FIGS. 2 and 3 indicates that the hierarchical model is a clearly superior for Topic 1, significantly outperforming the other conventional methodologies. For Topic 2 (FIG. 4) the nearest neighbor methodology is very competitive but the results drop off at approximately 0.35 (precision). This is precisely what is expected with the choice of the second topic. A look at the results of the pattern-matching proximity search helps explain the relative performance between the multi-stage EM and nearest neighbor. For Topic 1 the best performance for proximity search is a precision of 0.4, which drops to a low of 0.2 with increasing recall, while for Topic 2 the best performance is about 0.9 dropping to a low of just below 0.45. This indicates that Topic 2 is defined by simpler patterns than Topic 1.

The reason for the drop in performance of the hierarchical model for Topic 2 can be best explained as follows. It has been shown before that modeling text data is accomplished better in lower dimensional subspaces. Techniques such as LSI^{[2]} and PLSI^{[3]} have been proposed for this purpose. For unsupervised learning in text, it has shown that feature selection is important in identifying appropriate underlying topics^{[10]}. It is believed that learning with unlabeled data feature selection is equally significant. The experiments used all features (except for very rare and very common tokens), which increase the varying results produced by Topic 2. This effect is less pronounced in Topic 1 due the fact that the entire context surrounding all the seed anchors is relevant (a fact evident from the poor performance of the proximity pattern search).

The requirement for a topic-specific, named-entity list can be a potential drawback. To check the sensitivity of our methodology to the choice of the named-entity tagger experiments were performed on Topic 1 (chip manufacturing) using both a topic-specific named-entity list (FIG. 2) and a broader list of companies (FIG. 3). It is can be seen in FIGS. 2 and 3 that both the nearest neighbor and the multistage EM methodologies display a slight drop in accuracy with a non-topic specific list, but the results still show sign ificant precision numbers, and in particular the multistage EM behaves very well. The use of a semi-supervised, single level, latent variable model, is also investigated using conventional approaches^{[6]}. The methodology was run for several different numbers of clusters ranging from 20 to 100 and the results were significantly worse than those of the other methodologies.

Information extraction from text is an extremely important problem with some major challenges. In particular it introduces the problem of single-class learning with very few labeled examples. The invention addresses this problem with a novel, clipped hierarchical latent variable model. Further, the invention provides a new variant of the EM methodology to learn the parameters of this model. The results on real-world examples reflect the validity of the invention.

A system in accordance with an embodiment of the invention is shown in FIG. 5, whereby the system 200 for extracting information comprises a query input 201; a database 203 of documents 210; a plurality of classifiers 202₁, . . . ,202ₙ arranged in a hierarchical cascade 202 of classifier layers 204, wherein each classifier 202₁, . . . ,202ₙ comprises a set of weighted training data points (not shown) comprising feature vectors (not shown) representing any portion of a document 210, and wherein the classifiers 202₁, . . . ,202ₙ are operable to retrieve documents 210 from the database 203 matching the query input 201; and a terminal classifier 205 weighing an output from the cascade 202 according to a rate of success of query terms being matched by each layer of the cascade 202.

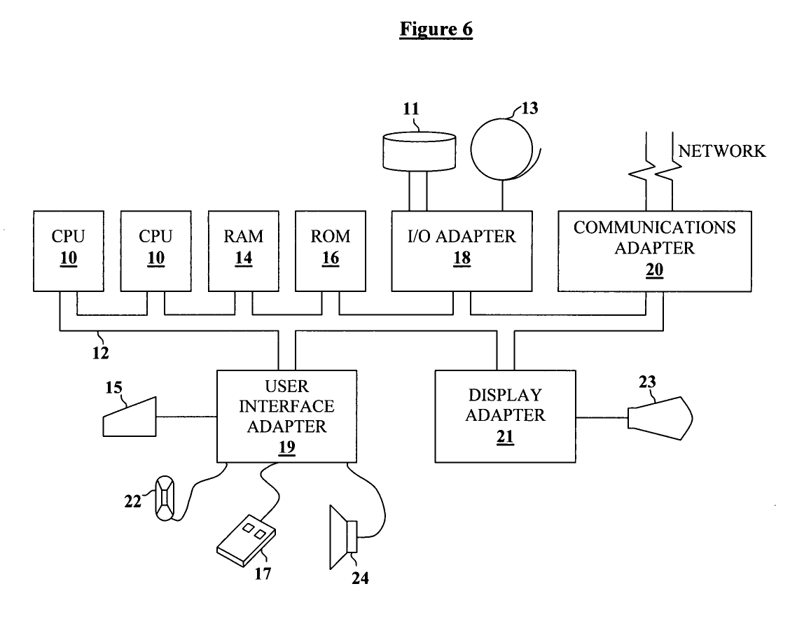

A representative hardware environment for practicing the present invention is depicted in FIG. 6, which illustrates a typical hardware configuration of an information handling/computer system in accordance with the invention, having at least one processor or central processing unit (CPU) 10. The CPUs 10 are interconnected via system bus 12 to random access memory (RAM) 14, read-only memory (ROM) 16, an input/output (I/O) adapter 18 for connecting peripheral devices, such as disk units 11 and tape drives 13, to bus 12, user interface adapter 19 for connecting keyboard 15, mouse 17, speaker 24, microphone 22, and/or other user interface devices such as a touch screen device (not shown) to bus 12, communication adapter 20 for connecting the information handling system to a data processing network, and display adapter 21 for connecting bus 12 to display device 23. A program storage device readable by the disk or tape units is used to load the instructions, which operate the invention, which is loaded onto the computer system.

Thus, the invention provides a technique of organizing and retrieving documents based on a query, whereby a few (minimum number of) example documents are used as a basis for the query. Then, using the query, the invention uses a cascade of classifiers, which act as filters filtering the documents for relevancy against the particular query input. The invention performs an expectation maximum methodology at each level of the cascade of classifiers in order to generate an output for each classifier indicating the relevancy of that particular classifier for the query. The invention arranges the output using a terminal classifier in such a way as to provide a user with the most relevant documents in a database, which match, or most closely match, the query. The invention is able to achieve high recall query by using multistage semi-supervised learning in its application of the expectation maximum methodology. In fact, the invention is able to retrieve and sort many documents based on just a few documents as a starting point for the query.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the invention can be practiced with modification within the spirit and scope of the appended claims.

### REFERENCES

[1] Amari, S., “Information geometry of the EM and EM algorithms for neural networks,” Neural Networks, 8, 1379-1408, 1995.
[2] Deerwester, S. C. et al., “Indexing by latent semantic analysis,” Journal of the American Society of Information Science, 41, 391-407, 1990.
[3] Hofmann, T., “Probabilistic Latent Semantic Indexing,” Proceedings of the 22nd Annual ACM Conference on Research and Development in Information Retrieval, 50-57, Berkeley, Calif., 1999.
[4] Liu, B. et al., “Partially supervised classification of text documents,” International Conference On Machine Learning, 2002.
[5] Manevitz, L. et al., “One class SVMs for document classification,” Journal of Machine Learning Research, 2, 2001.
[6] Nigam, K. et al., “Text classification from labeled and unlabeled documents using EM,” Machine Learning, 39, 103-34, 2000.
[7] Ravin, Y. et al., “Disambiguations of names in text,” Proceedings Of The Fifth Conference On Applied Natural Language Processing, 1997.
[8] Rosset, S. et al., “Boosting density estimation,” NIPS, 2002.
[9] Scholkopf, B. et al., “Estimating the support of a high dimensional distribution,” Neural Computation, 13, 1443-1471, 2001.
[10] Vaithyanathan, S. et al., “Model-based hierarchical clustering” Proceedings of ICML-2000, 17th International Conference on Machine Learning, 599-608, 2000.
[11] Yang, Y. et al., “A re-examination of text categorization methods,” Proceedings of SIGIR-99, 22nd ACM International Conference on Research and Development in Information Retrieval, 42-49, 1999.
[12] Yu, H. et al., “Pebl: Positive example based learning for web page classification using svm,” Proceedings of 2002 SIGKDD Conference, 239-248, 2002.

1. A system for extracting information comprising:
a query input;
a database of documents;
a plurality of classifiers arranged in a hierarchical cascade of classifier layers, wherein each classifier comprises a set of weighted training data points comprising feature vectors representing any portion of a document, and wherein said classifiers are operable to retrieve documents from said database matching said query input; and
a terminal classifier weighing an output from said cascade according to a rate of success of query terms being matched by each layer of said cascade.

2. The system of claim 1, wherein each classifier accepts an input distribution of data points and transforms said input distribution to an output distribution of said data points.

3. The system of claim 2, wherein each classifier is trained by weighing training data points at each classifier layer in said cascade by an output distribution generated by each previous classifier layer, and wherein weights of said training data points of said first classifier layer are uniform.

4. The system of claim 3, wherein each classifier is trained according to said query input.

5. The system of claim 2, wherein said query input is based on a minimum number of example documents.

6. The system of claim 1, wherein said document comprises data points comprising feature vectors representing any portion of said document.

7. The system of claim 1, wherein said documents comprise a file format capable of being represented by said feature vectors.

8. The system of claim 1, wherein said documents comprise any of text files, images, web pages, video files, and audio files.

9. The system of claim 2, wherein a classifier at each layer in said hierarchical cascade is trained for each layer with an expectation maximization methodology that maximizes a likelihood of a joint distribution of said training data points and latent variables.

10. The system of claim 9, wherein each layer of said cascade of classifiers is trained in succession from a previous layer by said expectation maximization methodology, wherein said output distribution is used as an input distribution for a succeeding layer.

11. The system of claim 9, wherein each layer of said cascade of classifiers is trained by successive iterations of said expectation maximization methodology until a convergence of parameter values associated with said output distribution of each layer occurs in succession.

12. The system of claim 11, wherein said successive iterations comprise a fixed number of iterations.

13. The system of claim 9, wherein all layers of said cascade of classifiers are trained by successive iterations of said expectation maximization methodology until a convergence of parameter values associated with output distributions of all layers occurs, wherein during each step of the of said iterations, the output distribution of each layer is used to weigh the input distribution of a succeeding layer.

14. The system of claim 13, wherein said successive iterations comprise a fixed number of iterations.

15. The system of claim 2, wherein each classifier layer generates a relevancy score associated with each a data point, wherein said relevancy score comprises an indication of how closely matched said data point is to said example documents.

16. The system of claim 2, wherein each classifier layer generates a relevancy score associated with said document, wherein said relevancy score is calculated from relevancy scores of individual data points within said document.

17. The system of claim 5, wherein said terminal classifier generates a relevancy score associated with each data point, wherein said relevancy score comprises an indication of how closely matched said data point is to said example documents, and wherein said relevancy score is computed by combining relevancy scores generated by classifiers at each layer of the cascade.

18. The system of claim 2, wherein said terminal classifier generates a relevancy score associated with a document, wherein said relevancy score is calculated from relevancy scores of individual data points within said document.

19. The system of claim 1, wherein features of said feature vectors comprise words within a range of words located proximate to entities of interest in said document.

20. A method of extracting information, said method comprising:
inputting a query;
searching a database of documents based on said query;
retrieving documents from said database matching said query using a plurality of classifiers arranged in a hierarchical cascade of classifier layers, wherein each classifier comprises a set of weighted training data points comprising feature vectors representing any portion of a document; and
weighing an output from said cascade according to a rate of success of query terms being matched by each layer of said cascade, wherein said weighing is performed using a terminal classifier.

21. The method of claim 20, wherein each classifier accepts an input distribution of data points and transforms said input distribution to an output distribution of said data points.

22. The method of claim 21, wherein each classifier is trained by weighing training data points at each classifier layer in said cascade by an output distribution generated by each previous classifier layer, and wherein weights of said training data points of said first classifier layer are uniform.

23. The method of claim 22, wherein each classifier is trained according to said query input.

24. The method of claim 21, wherein said query input is based on a minimum number of example documents.

25. The method of claim 20, wherein said document comprises data points comprising feature vectors representing any portion of said document.

26. The method of claim 20, wherein said documents comprise a file format capable of being represented by said feature vectors.

27. The method of claim 20, wherein said documents comprise any of text files, images, web pages, video files, and audio files.

28. The method of claim 21, wherein a classifier at each layer in said hierarchical cascade is trained for each layer with an expectation maximization methodology that maximizes a likelihood of a joint distribution of said training data points and latent variables.

29. The method of claim 28, wherein each layer of said cascade of classifiers is trained in succession from a previous layer by said expectation maximization methodology, wherein said output distribution is used as an input distribution for a succeeding layer.

30. The method of claim 28, wherein each layer of said cascade of classifiers is trained by successive iterations of said expectation maximization methodology until a convergence of parameter values associated with said output distribution of each layer occurs in succession.

31. The method of claim 30, wherein said successive iterations comprise a fixed number of iterations.

32. The method of claim 28, wherein all layers of said cascade of classifiers are trained by successive iterations of said expectation maximization methodology until a convergence of parameter values associated with output distributions of all layers occurs, wherein during each step of the of said iterations, the output distribution of each layer is used to weigh the input distribution of a succeeding layer.

33. The method of claim 32, wherein said successive iterations comprise a fixed number of iterations.

34. The method of claim 21, wherein each classifier layer generates a relevancy score associated with each a data point, wherein said relevancy score comprises an indication of how closely matched said data point is to said example documents.

35. The method of claim 21, wherein each classifier layer generates a relevancy score associated with said document, wherein said relevancy score is calculated from relevancy scores of individual data points within said document.

36. The method of claim 24, wherein said terminal classifier generates a relevancy score associated with each data point, wherein said relevancy score comprises an indication of how closely matched said data point is to said example documents, and wherein said relevancy score is computed by combining relevancy scores generated by classifiers at each layer of the cascade.

37. The method of claim 21, wherein said terminal classifier generates a relevancy score associated with a document, wherein said relevancy score is calculated from relevancy scores of individual data points within said document.

38. The method of claim 20, wherein features of said feature vectors comprise words within a range of words located proximate to entities of interest in said document.

39. A program storage device readable by computer, tangibly embodying a program of instructions executable by said computer to perform a program storage device of extracting information, said program storage device comprising:
inputting a query;
searching a database of documents based on said query;
retrieving documents from said database matching said query using a plurality of classifiers arranged in a hierarchical cascade of classifier layers, wherein each classifier comprises a set of weighted training data points comprising feature vectors representing any portion of a document; and
weighing an output from said cascade according to a rate of success of query terms being matched by each layer of said cascade, wherein said weighing is performed using a terminal classifier.

40. The program storage device of claim 19, wherein each classifier accepts an input distribution of data points and transforms said input distribution to an output distribution of said data points.

41. The program storage device of claim 40, wherein each classifier is trained by weighing training data points at each classifier layer in said cascade by an output distribution generated by each previous classifier layer, and wherein weights of said training data points of said first classifier layer are uniform.

42. The program storage device of claim 41, wherein each classifier is trained according to said query input.

43. The program storage device of claim 40, wherein said query input is based on a minimum number of example documents.

44. The program storage device of claim 39, wherein said document comprises data points comprising feature vectors representing any portion of said document.

45. The program storage device of claim 39, wherein said documents comprise a file format capable of being represented by said feature vectors.

46. The program storage device of claim 39, wherein said documents comprise any of text files, images, web pages, video files, and audio files.

47. The program storage device of claim 40, wherein a classifier at each layer in said hierarchical cascade is trained for each layer with an expectation maximization methodology that maximizes a likelihood of a joint distribution of said training data points and latent variables.

48. The program storage device of claim 47, wherein each layer of said cascade of classifiers is trained in succession from a previous layer by said expectation maximization methodology, wherein said output distribution is used as an input distribution for a succeeding layer.

49. The program storage device of claim 47, wherein each layer of said cascade of classifiers is trained by successive iterations of said expectation maximization methodology until a convergence of parameter values associated with said output distribution of each layer occurs in succession.

50. The program storage device of claim 49, wherein said successive iterations comprise a fixed number of iterations.

51. The program storage device of claim 47, wherein all layers of said cascade of classifiers are trained by successive iterations of said expectation maximization methodology until a convergence of parameter values associated with output distributions of all layers occurs, wherein during each step of the of said iterations, the output distribution of each layer is used to weigh the input distribution of a succeeding layer.

52. The program storage device of claim 51, wherein said successive iterations comprise a fixed number of iterations.

53. The program storage device of claim 40, wherein each classifier layer generates a relevancy score associated with each a data point, wherein said relevancy score comprises an indication of how closely matched said data point is to said example documents.

54. The program storage device of claim 40, wherein each classifier layer generates a relevancy score associated with said document, wherein said relevancy score is calculated from relevancy scores of individual data points within said document.

55. The program storage device of claim 43, wherein said terminal classifier generates a relevancy score associated with each data point, wherein said relevancy score comprises an indication of how closely matched said data point is to said example documents, and wherein said relevancy score is computed by combining relevancy scores generated by classifiers at each layer of the cascade.

56. The program storage device of claim 40, wherein said terminal classifier generates a relevancy score associated with a document, wherein said relevancy score is calculated from relevancy scores of individual data points within said document.

57. The program storage device of claim 39, wherein features of said feature vectors comprise words within a range of words located proximate to entities of interest in said document.
